(19) United States
(12) Patent Application Publication
(10) Pub. No.: US 2009/0277315 A1
(43) Pub. Date: Nov. 12, 2009

(54) TILE SAW

(76) Inventors: Alek Ipatenco, Belton, SC (US); Michael Hart, Anderson, SC (US); Ryan Peloquin, Anderson, SC (US); Doug Ritterling, Anderson, SC (US); Kenneth M. Brazell, Piedmont, SC (US); Dennis Kuykendall, Easley, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/431,819

(22) Filed: Apr. 29, 2009

Related U.S. Application Data
(60) Provisional application No. 61/104,567, filed on Oct. 10, 2008.
(60) Provisional application No. 61/126,891, filed on May 8, 2008.

(51) Int. Cl. B26D 7/08; B26D 1/14; B26D 7/27; B26D 7/01

(52) U.S. Cl. 83/171; 83/471; 83/522.11; 83/467.1

(57) ABSTRACT

A tile saw that includes a base, a frame assembly disposed on the base, a rail assembly disposed on the frame assembly, and a cutting table slidingly disposed on the frame assembly and including a front fence. A saw assembly is disposed on at least one of the base and the frame assembly, and includes a motor and a cutting wheel driven by the motor. One of a miter guide and a bevel block is selectively lockable to the front fence.

### RELATED APPLICATION DATA

This application claims the benefit of U.S. Provisional Patent Application No. 61/104,567, filed Oct. 10, 2008, and of U.S. Provisional Patent Application No. 61/126,891, filed May 8, 2008 the entire contents of each are hereby incorporated by reference.

### BACKGROUND

The present invention relates to a portable tile saw. The portable saw can be placed directly on a support surface or can be supported above the support surface by a stand. The portable tile saw of the present invention also provides several features that may be desirable from a consumer standpoint.

### SUMMARY

The present invention provides a tile saw having a base and a frame disposed on the base. The base has a floor with upstanding walls to contain fluid and debris resulting from the cutting operation. A rail assembly is disposed on the frame assembly and provides support for a cutting table. The cutting table is movable in a longitudinal direction along the rail assembly. A saw support assembly is connected to the frame assembly to support a saw assembly. The saw assembly includes a motor assembly that drives a cutting wheel. The tile saw is provided with a fluid delivery system that includes a valve disposed on the saw support assembly to control fluid delivered to an area near the cutting wheel. Desirably, the saw support assembly includes a channel to separate the fluid delivery assembly from other components of the tile saw, such as electrical components.

The cutting table of the tile saw is configured to slide along the rail assembly such that a portion of the cutting table extends beyond a wall of the base. The tile saw of the present invention includes a stop to provide an indication when an end of the cutting table approaches the cutting wheel.

In one construction, the invention provides a tile saw that includes a base, a frame assembly disposed on the base, a rail assembly disposed on the frame assembly, and a cutting table slidingly disposed on the frame assembly and including a front fence. A saw assembly is disposed on at least one of the base and the frame assembly, and includes a motor and a cutting wheel driven by the motor. One of a miter guide and a bevel block is selectively lockable to the front fence.

In another construction, the invention provides a tile saw that includes a base including a floor and at least one wall extending around a perimeter of the floor to at least partially enclose a space. The space is adapted to contain a liquid coolant. A saw assembly is coupled to the base and supports a blade. The blade is rotatable about an axis that defines an axis plane. A first rail is coupled to the base and extends in a direction normal to the axis plane and a second rail is coupled to the base and is positioned parallel to and spaced apart from the first rail. A cutting table is coupled to the first rail and the second rail and is movable in a direction parallel to the first rail between a first position and a second position in which a portion of the cutting table extends beyond the perimeter. A first bearing and a second bearing are fixedly attached to the cutting table and movably engaged with the first rail and a third bearing is fixedly attached to the cutting table and movably engaged with the second rail.

In still another construction, the invention provides a tile saw that includes a base including a floor and at least one wall extending around a perimeter of the floor to at least partially enclose a space. The space is adapted to contain a coolant. A saw assembly is coupled to the base and supports a blade. The blade is rotatable about an axis that defines an axis plane. A first rail is coupled to the base and extends in a direction normal to the axis plane and a second rail is coupled to the base and is positioned parallel to and spaced apart from the first rail. A cutting table is coupled to the first rail and the second rail and is movable in a direction parallel to the first rail between a first position and a second position in which a portion of the cutting table extends beyond the perimeter. The cutting table includes a top surface having a plurality of arc-shaped grooves.

Additional features and benefits of the present invention are described and will be apparent from the accompanying drawings and description below.

### BRIEF DESCRIPTION OF THE DRAWINGS

FIG. 1 is a front perspective view of a tile saw of the present invention mounted on a stand.

FIG. 2 is a front perspective view of the tile saw of FIG. 1 not mounted on a stand.

FIG. 3a shows a barrier with its ends joined to intersecting walls of the base.

FIG. 3b shows the top profile of a portion of the barrier.

FIG. 4 illustrates a grate configuration provided adjacent a drain hole.

FIG. 5 illustrates a pump placed within an area circumscribed by the barrier.

FIG. 6 shows a stand useful with the tile saw of the present invention where the tile saw is shown in phantom to better illustrate the notches provided on the base that receive the beams of the stand.

FIG. 7 is a bottom view of the tile saw and stand.

FIG. 8 is a close up view of a portion of a stand that can be used with the tile saw of FIG. 1 to illustrate the pivot stop.

FIG. 9 is a rear perspective view of the cutting table for the tile saw of FIG. 1.

FIG. 10 is a rear perspective view of a portion of the cutting table that illustrates corner supports located on the top surface of the cutting table that provide support for the workpiece, typically a corner portion of the workpiece.

FIG. 11 is a side cross sectional view taken along line 11-11 of FIG. 1 and illustrating a stop assembly for the tile saw of FIG. 1.

FIG. 12 is a depiction of the operation of the stop assembly of FIG. 11, where FIG. 12a shows the stop assembly in a ready position, FIG. 12b shows the stop assembly at the initiation of engagement, i.e., where the front of the cutting table approaches the cutting wheel, and FIG. 12c shows the stop assembly fully depressed such that the cutting table cannot be moved further in a rearward direction.

FIG. 13 shows a miter guide useful with the tile saw of FIG. 1.

FIG. 14 shows a bevel block useful with the tile saw of FIG. 1.

FIG. 15 shows a portion of the tile saw and in particular the saw support assembly with a portion cut away and with a portion of the saw assembly removed to better illustrate certain features of the tile saw of FIG. 1.

FIG. 16 is a view of a portion of the arm of the saw support assembly with a portion of the saw assembly removed to better illustrate features of the tile saw of FIG. 1.

FIG. 17 is a perspective view of a portion of the rear of the tile saw of FIG. 1 illustrating a portion of the fluid delivery assembly.

FIG. 18 is a perspective view of a portion of the saw support assembly illustrating the separate channel provided for the fluid delivery system.

FIG. 19 is a perspective view of the tile saw of FIG. 1 with certain portions shown in phantom lines so that the rail assembly features of FIG. 1 can be better seen.

FIG. 20 is a perspective view of a bearing engageable with the rail assembly of FIG. 19.

FIG. 21 is an end view of the bearing of FIG. 20 in an unloaded condition and engaged with the rail assembly of FIG. 19.

FIG. 22 is a schematic illustration of a bevel block including a tab.

FIG. 23 is a perspective view of the bevel block of FIG. 22 with the tab positioned within a channel.

FIG. 24 is an enlarged perspective view of a portion of the bevel block of FIG. 23 better illustrating the tab and the channel.

### DETAILED DESCRIPTION

The invention is described with reference to the drawings in which like elements are referred to by like numerals. The relationship and functioning of the various elements of this invention are better understood by the following description. Each aspect so defined may be combined with any other aspect or aspects unless clearly indicated to the contrary. The embodiments described below are by way of example only, and the invention is not limited to the embodiments illustrated in the drawings.

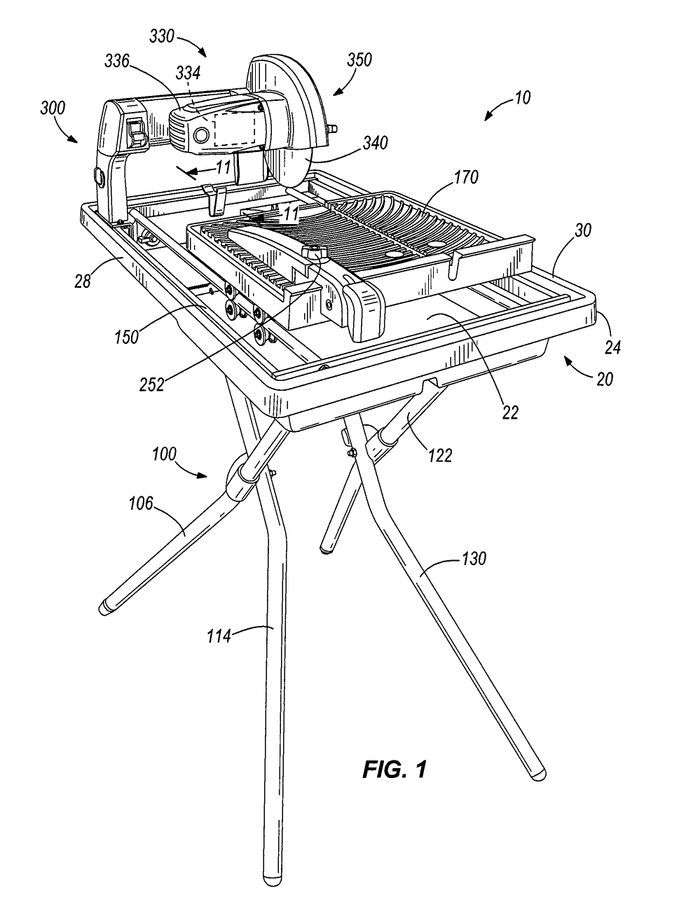

Turning now to FIG. 1, one embodiment of a tile saw 10 of the present invention is shown supported on a stand 100. The tile saw 10 includes a base 20 with a frame assembly 150 disposed on the base 20. The frame assembly 150 includes a rail assembly 160 on which a cutting table 170 moves. The frame assembly 150 includes a saw support assembly 300 from which a saw assembly 330 is supported. The saw assembly 330 includes a motor assembly 332 for driving a cutting wheel 340 for cutting a workpiece (not shown), such as a tile, disposed on the cutting table 170 when it is moved into contact with the cutting wheel 340.

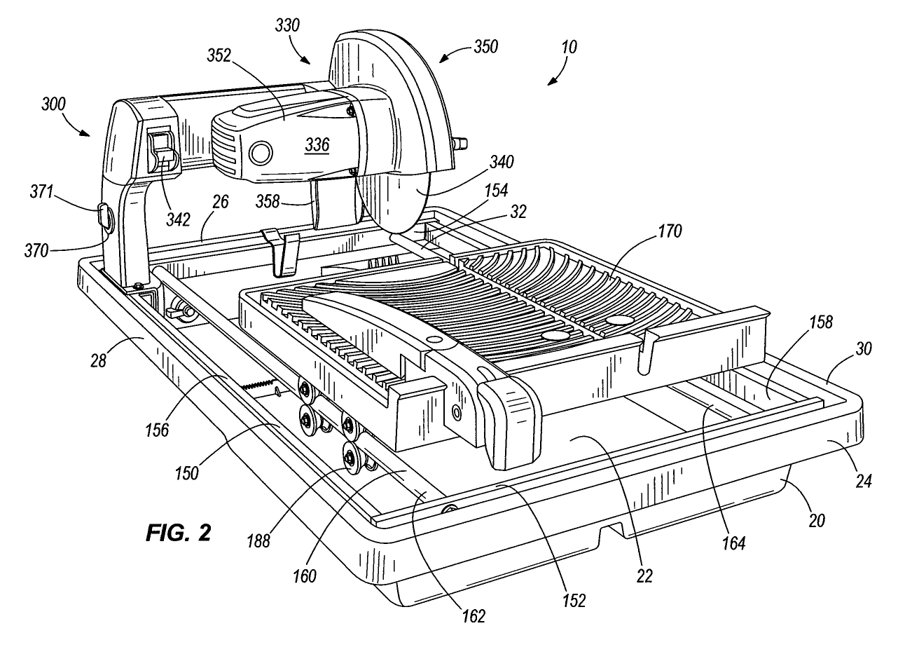

Turning now to FIG. 2, details of the tile saw 10 will be described. The base 10 includes a floor 22 with a front wall 24, a rear wall 26 spaced from the front wall 24, and two spaced apart side walls 28, 30 extending upward from the floor to contain fluids. A ledge 32 is provided around the inner periphery of the base 20 and is disposed between the floor 22 and the top of the walls. The base 20 is typically formed from durable plastic so that it is lightweight yet durable such as polypropylene, ABS, or other known plastic. The base 20 can be injection molded or vacuum formed. Alternatively, the base 20 could be formed from metallic materials such as steel or aluminum. The base 20 is also configured to support the different elements of the tile saw 10, as described below.

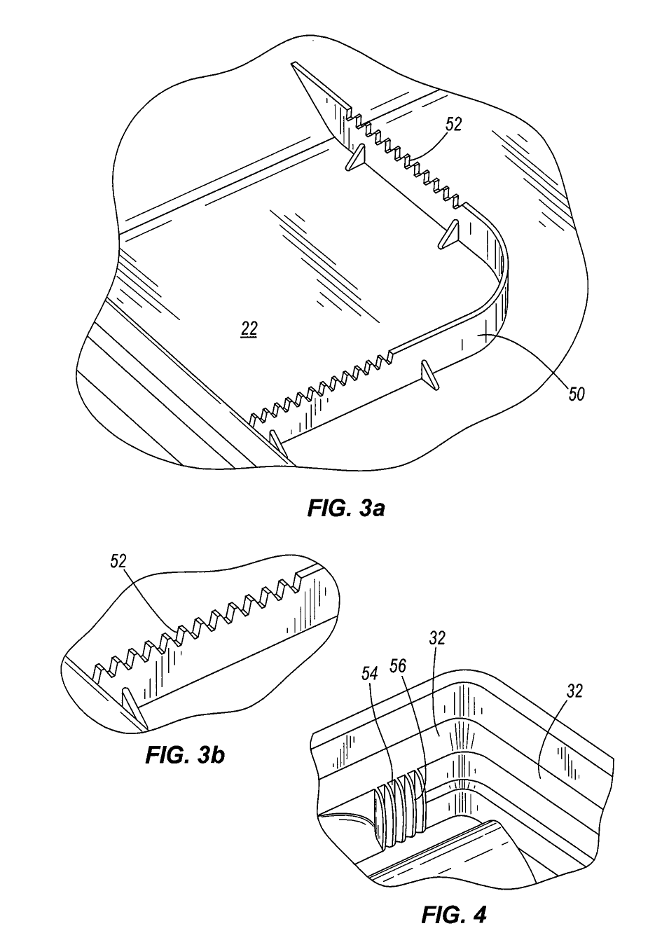

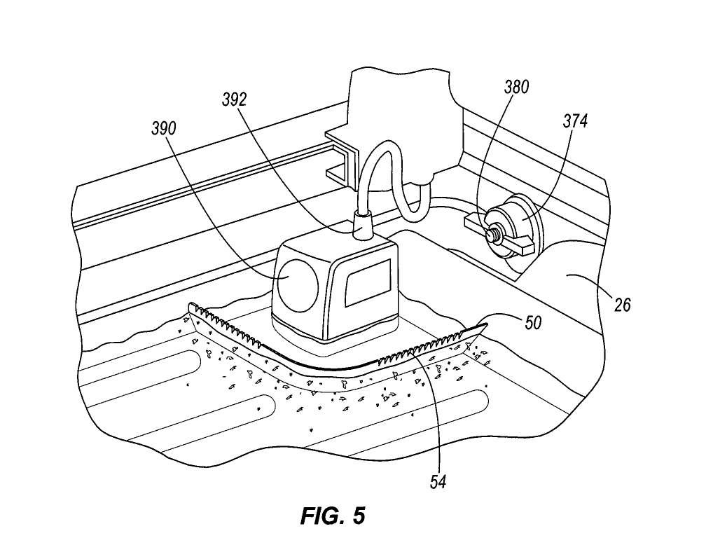

Referring to FIGS. 3a and 3b, the floor 22 of the base 20 is provided with a barrier 50 that extends from the floor 22 to contain sediment and pieces of the cut workpiece in a certain location of the base 20. The barrier 50 is configured to prevent the sediment and pieces of debris from moving toward either or both of a drain 54 or a pump 390, which may be provided near the rear wall 26 of the base 20, as depicted in FIG. 5. An upper edge 52 of the barrier 50 may be configured with a serrated edge to allow water to flow past the barrier 50 yet hinder sediment and pieces of the workpiece from moving past the barrier 50.

As best seen in FIG. 4, the rear wall 26 of the base 20 includes a drain 54 so that fluid (such as water) that accumulates within the base 20 can be easily removed without having to tilt or turn the base 20 over. A grate 56 surrounds the drain 54 to hinder or prevent sediment or pieces from the workpiece from exiting through the drain 54. The outlet of the drain 54 may be fluidly connected to a waste receptacle (not shown) for disposal of the fluid. It is contemplated to provide a barrier 50 near the drain 54 to further prevent debris from entering the drain 54.

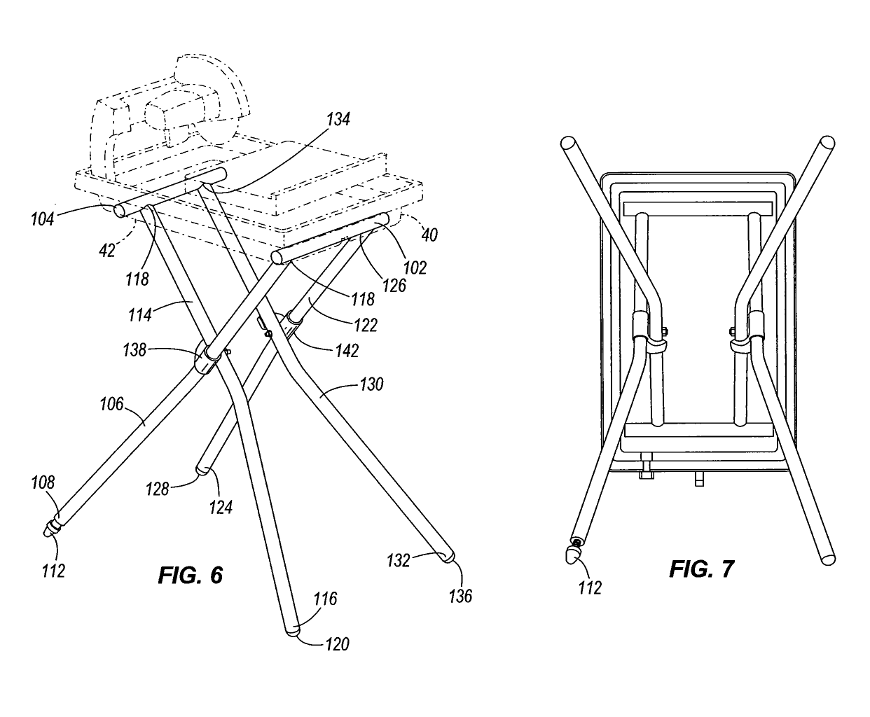

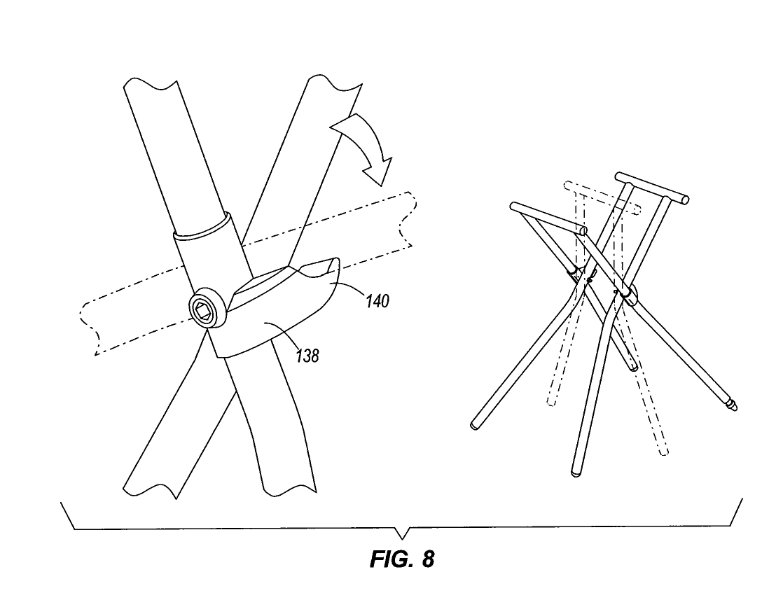

Referring to FIGS. 1, 6, 7, and 8, the base 20 (and thus the tile saw 10) may be supported by a stand 100. Preferably, the base 20 has at least one notch 40, 42 formed in the underside of the base. The notch 40, 42 may extend the entire width of the base 20 or just along a portion of the width of the base 20. Typically, the base 20 has two notches 40, 42 formed in the underside of the base 20. A forward notch 40 is located near the front of the base 20, while a rearward notch 42 is located near the rear of the base 20.

The stand 100 is a scissors type stand. While a scissor type stand is shown, one of skill in the art will understand that any stand configured to provide support for the base 20 will be suitable. The stand has two beams 102, 104 that, when the stand 100 is expanded (to a use position), will engage the respective notches 40, 42 provided on the underside of the base 20 to removably secure the base 20 to the stand 100. The beams 102, 104 are typically configured so that they have a shape that is complementary with the shape of the notches 40, 42 and so that the beams 102, 104 will be secured within the notches 40, 42 without the need for additional securing elements. While an additional securing member is not necessary, such a securing member is contemplated to provide an additional securing means. The securing member can be a bracket, a screw, or other structure that will removably secure the beam 102, 104 within the notch 40, 42.

The stand 100 has four legs 106, 114, 122, and 130 such that two legs are linked on one side of the base 20 and the other two are linked on the opposite side of the base 20. On one side, a first leg 106 has a first end 108 that contacts the floor, ground, or surface on which the stand 100 is located. The first leg 106 has a second end 110 that is connected with the beam 102 that engages the notch 40 at the forward portion of the base 20. The first end 108 of the first leg 106 is provided with a rotatable adjusting knob 112 so that the base 200 can be adjusted to be level. The first leg 106 is pivotally connected to a second leg 114 at a location between the first end 108 and the second end 110.

The second leg 114 has a first end 116 that contacts the surface on which the stand 100 is located and a second end 118 that is connected with the second beam 104 that engages the notch 42 at the rear portion of the base 20. The first end 116 of the second leg 114 is provided with a rotatable adjusting knob 120 so that the base 20 can be adjusted to be level.

A third leg 122 and a fourth leg 130 are configured in a manner similar to the first leg 106 and second leg 114. Accordingly, a third leg 122 has a first end 124 that contacts the floor, ground, or surface on which the stand 100 is located. The third leg 122 has a second end 126 that is connected with the beam 102 that engages the notch 40 at the forward portion of the base 20. The first end 124 of the third leg 122 is provided with a rotatable adjusting knob 128 so that the base 20 can be adjusted to be level. The third leg 122 is pivotally connected to a fourth leg 130 at a location between the first end 124 and the second end 126.

The fourth leg 130 has a first end 132 that contacts the surface on which the stand 100 is located and a second end 134 that is connected with the beam 104 that engages the notch 42 at the rear portion of the base 20. The first end 132 of the fourth leg 130 is provided with a rotatable adjusting knob 136 so that the base 20 can be adjusted to be level.

When the stand 100 is expanded to a use position, as best seen in FIG. 7, each of the first ends 108, 116, 124, and 132 of each of the legs 106, 114, 122, and 130 will extend beyond a plane defined by the side walls 28, 30 of the base 20 and beyond the front 24 and rear 26 walls of the base 20. In addition, the first end 108, 124 of each of the first and third legs 106, 122 will extend beyond a plane defined by the rear wall 26 of the base 20 a distance that is greater than the distance that the first end 116, 132 of each of the second and fourth legs 114, 130 extends beyond a plane defined by the front wall 24 of the base 20. Advantageously, this configuration provides good support for the base 20 yet does not provide a distraction to the user at the front of the base 20.

A first bracket 138 is provided on one of the first and second legs 106, 114 and a second bracket 142 is provided on one of the third and fourth legs 122, 130 to link each of the first and second legs 106, 114 and each of the third and fourth legs 122, 130. Each of the first and second brackets 138, 142 has an arm 140, 144, respectively that extends toward the other of the first and second leg 106, 114 and the other of the third and fourth leg 122, 130 to limit the pivoting travel of the legs with respect to each other.

Turning back to FIGS. 1 and 2, a frame assembly 150 is disposed on the base 20. The frame assembly 150 is dimensioned such that the frame assembly 150 is disposed within the outer periphery of the base 20, which will allow the tile saw 10 to be easily transported. The frame assembly 150 may be made of any suitable material that is structurally stable to provide support for the cutting table 170, the workpiece, the saw support assembly 300 and other components. In one embodiment, the frame assembly 150 is formed from aluminum.

The frame assembly 150 is supported by the ledge 32 that extends about the inner periphery of the base 20. The frame assembly 150 may be secured to the base 20 by brackets, screws, or other securing members. The frame assembly 150 has a front 152, a rear 154, a first side 156, and a second side 158. The front 152 of the frame assembly is adjacent the front wall 24 of the base 20 and the rear of the frame 15 assembly 154 is adjacent the rear wall 26 of the base 20. Likewise, each of the sides of the frame assembly 156, 158 is adjacent respective side walls 28, 30 of the base 20.

The frame assembly 170 includes a rail assembly 160. The rail assembly 160 supports the cutting table 170 so that the cutting table 170 can move in a direction parallel to the cutting wheel 340. The rail assembly 160 includes a first rail 162 spaced from a first side of the frame assembly 156 and extends from the rear of the frame assembly 154 to the front of the frame assembly 152.

In another aspect of the present invention, the rail assembly 170 includes a first rail 162 and a second rail 164 spaced from the first rail 162, as best seen in FIG. 2. In this aspect, the second rail 164 is spaced from a second side of the frame assembly 158 and extends from the rear of the frame assembly 154 to the front of the frame assembly 152.

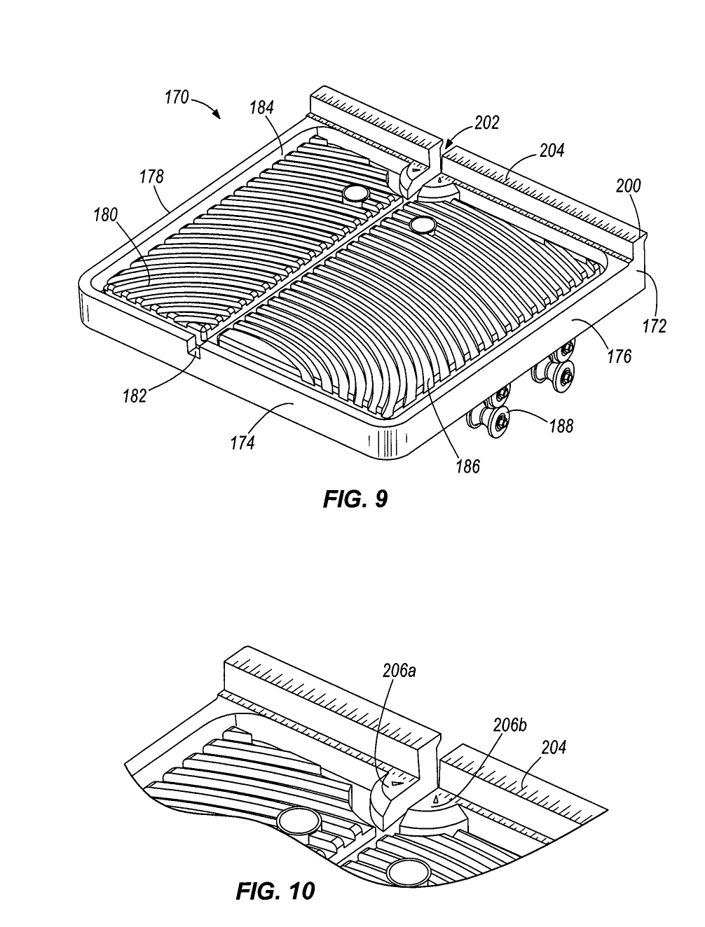

The cutting table 170 is movably connected to the rail assembly 160. Referring to FIGS. 9 and 10, the cutting table 170 has a front 172, a rear 174, a first side 176, a second side 178, and a top surface 180 with a cutting guide 182. While a single cutting guide 182 is shown, it is contemplated to provide more than one cutting guide 182, particularly when the cutting wheel 340 is laterally movable with respect to the base 20 and/or when the cutting wheel 340 is pivotable (e.g., to provide a bevel cut).

The top surface 180 may be made of any suitable material such as plastic or aluminum. The top surface 180 may also be provided with a material to hinder movement of the workpiece with respect to the cutting table 170. For example, the top surface 180 may be provided with rubber or another high-friction material. As shown in FIG. 9, the top surface 180 is provided with grooves 186 to direct fluid toward the cutting guide 182 or toward a peripheral channel 184 so that fluid can be directed from the top of the cutting table 170 to the base 20. Drain holes (not shown) can be provided in one or both of the cutting guide 182 or peripheral channel 184 to direct fluid from the top surface 180 to the base 20, where the fluid can be collected.

In one embodiment, as best seen in FIG. 9, the grooves 186 are provided in an arc-shaped or curved configuration. This configuration will ease placement of the workpiece on the top surface 180 of the cutting table 170 and will reduce the tendency of straight edges of a workpiece from hanging up in the grooves 186. Since the grooves are curved, straight edges of a tile or slate will not engage the edge of the groove. This allows the workpiece to slide smoothly during re-positioning. Tile can oftentimes have a groove pattern (either parallel lines or intersecting lines) on the backside, so the curved groove 186 configuration on the table also reduces the tendency for a tile's groove pattern on its backside to catch on the cutting table 170.

An upwardly extending front fence 200 is provided at the front 172 of the cutting table 170. The front fence 200 can be used to align a workpiece on the cutting table 170. The front fence 200 has a gap 202 aligned with the cutting guide 182 on the cutting table 170 so that the end of the workpiece adjacent the front fence can be cut. Advantageously, indicia 204 are provided on the top and inner edge of the fence. Indicia 204 may also be provided on the top surface 180 of the cutting table 170 adjacent the front fence 200 so that workpiece can be easily aligned for proper cutting.

Often, it is desired to cut the workpiece along a diagonal, which requires a corner of the workpiece to be placed adjacent the front fence 200. To provide support to the corner while it is being cut, a pair of supports 206a, 206b extend from the cutting table 170 adjacent the front fence 200 on either side of the cutting guide 182 and in a manner such that the peripheral channel 184 is adjacent the portion of the supports 206a, 206b distal from front fence 200. It is to be understood that the top surface of the supports 206a, 206b are in the same plane as the top surface of the cutting table 170 so that the workpiece is level as it is being cut.

As noted above, the top surface 180 of the cutting table 170 is provided with at least one cutting guide 182. The cutting guide 182 extends from the rear 174 of the cutting table to the front 172 of the cutting table to provide a guide for the cutting wheel 340. As the cutting table 170 is moved towards the cutting wheel 340, the workpiece disposed on top of the cutting table is cut. A portion of the cutting wheel 340 extends below the top surface 180 of cutting table 170. In particular, a portion of the cutting wheel 340 extends into the cutting guide 182 provided in the cutting table 170.

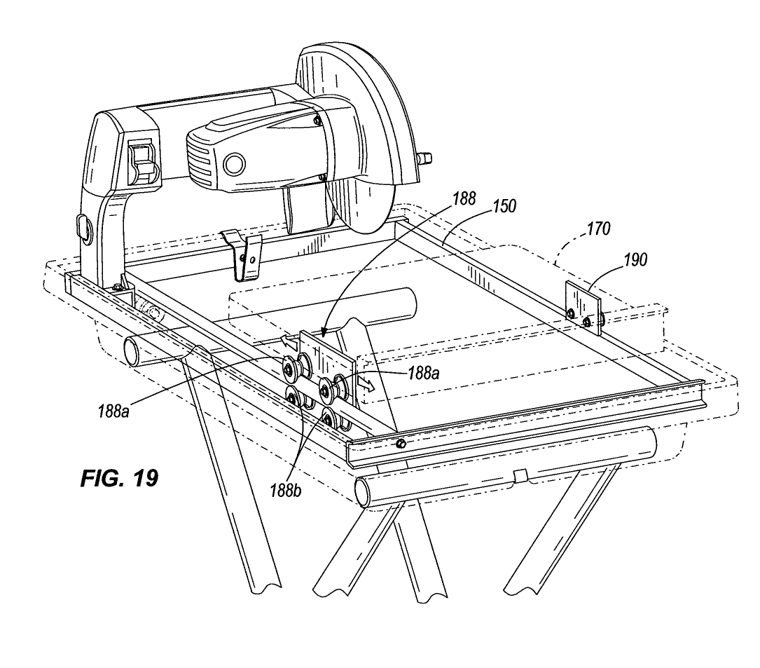

The cutting table 170 includes a number of bearings 188 associated with the rail assembly to allow the cutting table 170 to move with respect to the base 20. Referring to FIG. 19, in one embodiment, bearings 188 are connected to the cutting table 170 so that they are in contact with the first rail 162. The bearings 188 include a pair of U-shaped bearings 188a located vertically above the first rail 162 and a pair of U-shaped bearings 188b disposed vertically below the first rail 162 such that a bearing 188a is disposed above and generally in the same plane as a bearing 188b. Of course, it is to be understood that the bearings 188 can have any suitable arrangement to allow the bearings to contact the first rail 162 to permit the cutting table 170 to move with respect to the frame assembly 150 and base 20. For example, the bearings 188 may be ball bearings, roller bearings, linear bearings, or may simply be a non-rotatable element that can slide along the first rail 162. On the opposite side of the cutting table 170, a bearing 190 is provided. In one aspect, the bearing 190 is a stationary bearing that rides on the top surface of a side 156, 158 of the frame assembly.

In another embodiment best seen in FIG. 2, the rail assembly includes a second rail 164 generally parallel to and spaced from the first rail 162. In this embodiment, a second set of bearings similar to the bearings 188 described above can be provided so that the cutting table 170 can be moved with respect to the frame assembly 150 and the base 20. In particular, a pair of bearings 188 can be provided on the first side 176 of the cutting table 170 and another pair of bearings 188 is provided on the second side 178 of the cutting table 170 so that the cutting table is supported by the rail assembly 160. The bearings may have the structure illustrated in FIG. 19 or may have the structure described above.

The bearings 188, 189 are located near the midpoint between the front 172 and the rear 174 of the cutting table 170 so that the rear 174 of the cutting table 170 extends beyond the rear wall 26 of the base 20. In one aspect, as the front 172 of the cutting table 170 approaches the cutting wheel 340, the rear 174 of the cutting table 170 extends beyond the rear wall 26 of the base 20. This configuration allows the tile saw 10 to have a more compact construction.

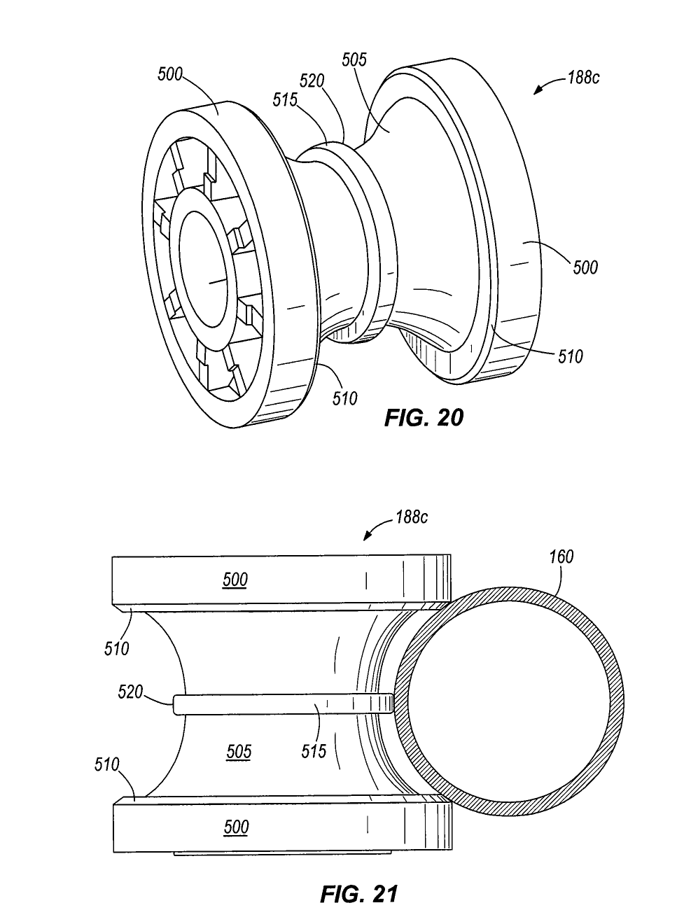

FIG. 20 illustrates another construction of a bearing 188c that is suitable for use to support the cutting table 170 for sliding motion. The bearing 188c includes two side portions 500 and a U-shaped portion 505 extending between the side portions 500. The side portions 500 include chamfered interior surfaces 510 that are angled to engage the rail assembly 160 such that the contact force between the rail assembly 160 and the chamfered surfaces 510 are applied in a direction that is approximately normal to the chamfered surfaces 510. A support rib 515 is positioned near or at the center of the U-shaped portion 505 to provide an additional surface for contact with the rail assembly 160 on which the bearing 188c rides. The support rib 515 includes a substantially cylindrical surface 520 that is positioned to engage the rail assembly 160 when the bearing 188c is loaded such that the contact force between the rail assembly 160 and the support rib 515 is applied in a direction that is substantially normal to the cylindrical surface 520. In the illustrated construction, the support rib 515 is formed as an integral component with the remainder of the bearing 188c. However, other constructions could employ a separate piece that attaches to the bearing 188c.

FIG. 21 illustrates the preferred contact points between the bearing 188c and the rail assembly 160. As illustrated, the bearing 188c includes two chamfered surfaces 510 that engage the rail assembly 160 and support the bearing 188c and the cutting table 170. The support rib 515 is positioned such that it does not contact the rail assembly 160 until the bearing 188c is loaded. As the bearing 188c is loaded, it deflects slightly and the support rib 515 moves into engagement with the rail assembly 160. Thus, the bearing 188c provides three contact surfaces 510, 520, while the bearings 188a and 188b provide two contact surfaces. The third contact surface 520 reduces wear on the two side contact surfaces 510, increases the life of the bearing 188c, and improves the stability of the motion of the cutting table 170 when compared to the bearings 188a, 188b. As already noted, still other bearing arrangements including ball bearings, roller bearings, linear bearings, and the like could also be employed if desired.

The cutting wheel 340 is located closer to the rear wall 26 of the base 20 than to the front wall 24. Accordingly, as the cutting table 170 is moved from the front of the base 20 toward the rear, the workpiece will contact the cutting wheel 340 and be cut. Advantageously, the tile saw 10 of the present invention includes a stop assembly 220. The stop assembly 220 will provide an indication that the front 172 of cutting table 170 nears the cutting wheel 340 and the end of the workpiece to be cut. Such an indication will provide the user with a reminder to slow the movement of the cutting table 170 to minimize or reduce breakage of the workpiece.

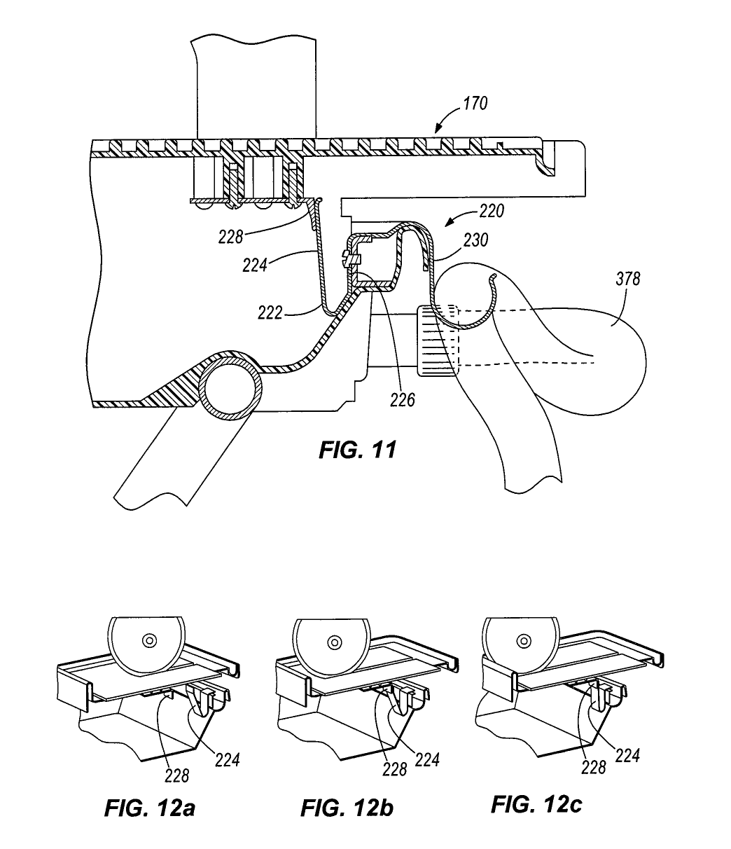

The stop assembly 220 includes a spring 222 connected to the rear of the base 20 and configured to contact a portion of the cutting table 170 when the front 172 of the cutting table approaches the forward-most portion of the cutting wheel 340. As seen in FIGS. 11 and 12, the spring 222 is fashioned as a U-shaped spring with a first arm 224 being connected to the base 20 and a second arm 226 configured to contact a portion of the cutting table 170. The spring can be made of spring steel or any other suitable material with resilient properties. The stop assembly 220 also includes a tab 228 associated with the cutting table 170 and configured to contact the second arm 226 of the spring 222. The tab 228 may be formed as part of the cutting table 170 or may be connected to the cutting table 170 with a screw or other attaching mechanism. Accordingly, it will be appreciated that as the cutting table 170 moves toward the rear of the base 20, the tab 228 will contact the spring 222 and provide resistance to travel in the same direction. Such resistance will provide an indication to the user that the cutting table 170 is nearing the end of its travel (i.e., the front 172 of the cutting table is approaching the cutting wheel 340).

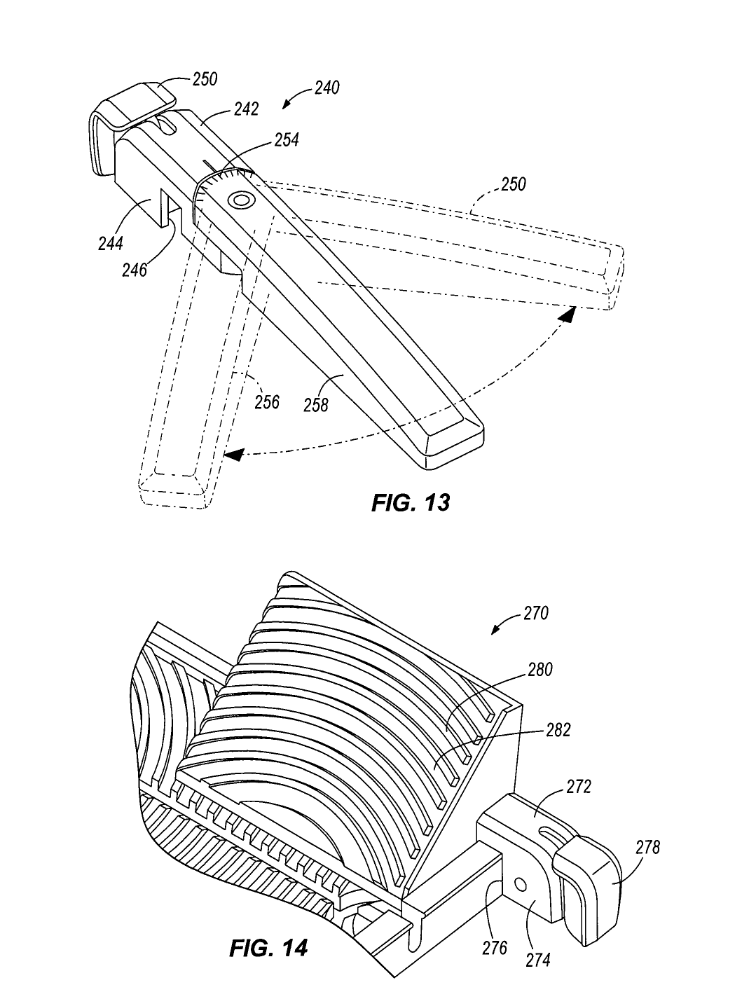

Referring to FIG. 13, a miter guide 240 is removably connected to the front fence 200. The miter guide 240 has a body 242 with a clamp 246 that allows the miter guide 240 to be removably connected to the front fence 200. The body 242 has a U-shaped notch 248 that is shaped to engage the front face 200. A cam (not shown) extends into the notch 248 and is actuated by a cam lever 250 accessible from the outer portion of the body 244 of the miter guide 240. In one position, the cam locks the miter guide 240 at a selected location on the front fence 200. In a second position, the cam is unlocked from the front fence 200 so that the miter guide 240 can be repositioned along or removed from the front fence 200.

The miter guide 240 has an arm 250 that is pivotable with respect to the body 242 of the miter guide 240. The arm 250 is pivotable about an axis that is substantially perpendicular to the top surface 180 of the cutting table 170. A locking mechanism 252 may be provided to lock the arm 250 at a selected position. For example, a locking screw may connect the arm 250 to the body 242. Indicia 254 is provided on a top surface of the body 244 of the miter guide 240 so that the desired pivot location of the arm 250 can be easily determined. The arm 250 has a surface 256, 258 on each side that is substantially perpendicular to the top surface 180 of the cutting table 170. Accordingly, a workpiece can be disposed against the front fence 200 and against one of the sides 256, 258 of the arm 250. Advantageously, the miter guide 240 can be disposed on either side of the cutting guide 182.

The tile saw 10 of the present invention may include a removable and repositionable bevel block 270, as best seen in FIG. 14. The bevel block 270 has a body 272 and a bevel surface 280 that is located at a preselected angle with respect to the top surface 180 of the cutting table 170. One such preselected angle is 45 degrees. The top surface 280 of the bevel block 270 may have arched grooves 282 similar to those provided on the top surface 190 of the cutting table 170.

The bevel block 270 is removably attached to the cutting table 170 by providing a cam lock to lock the bevel block 270 to the front fence 200 of the cutting table 170. In this regard, a cam lever 278 is provided on the body 272 of the bevel block 270, which has a U-shaped notch 276 to engage the front fence 200. A cam (not shown) extends into the notch 276 and is actuated by a cam lever 278 accessible from the outer portion of the body 272 of the bevel block 270. In one position, the cam locks the bevel block 270 at a selected location on the front fence 200. In a second position, the cam is unlocked from the front fence 200 so that the bevel block 270 can be repositioned along the front fence 200 or removed from the front fence 200.

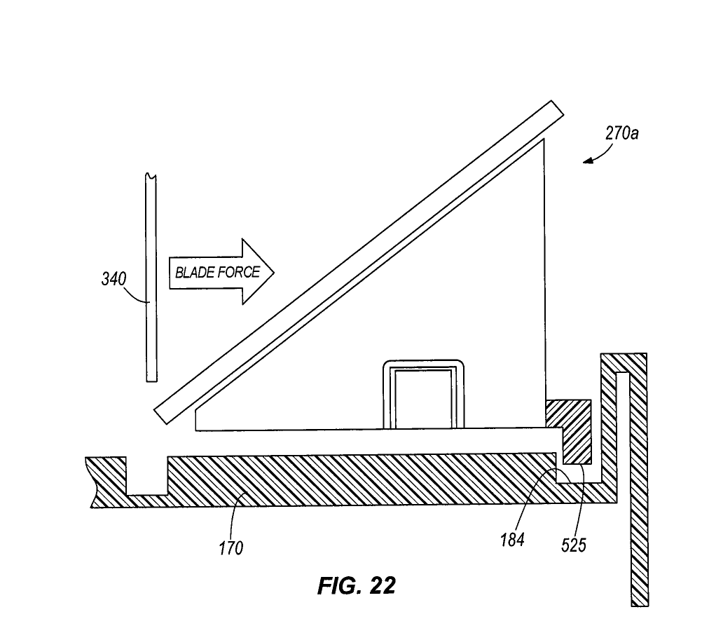

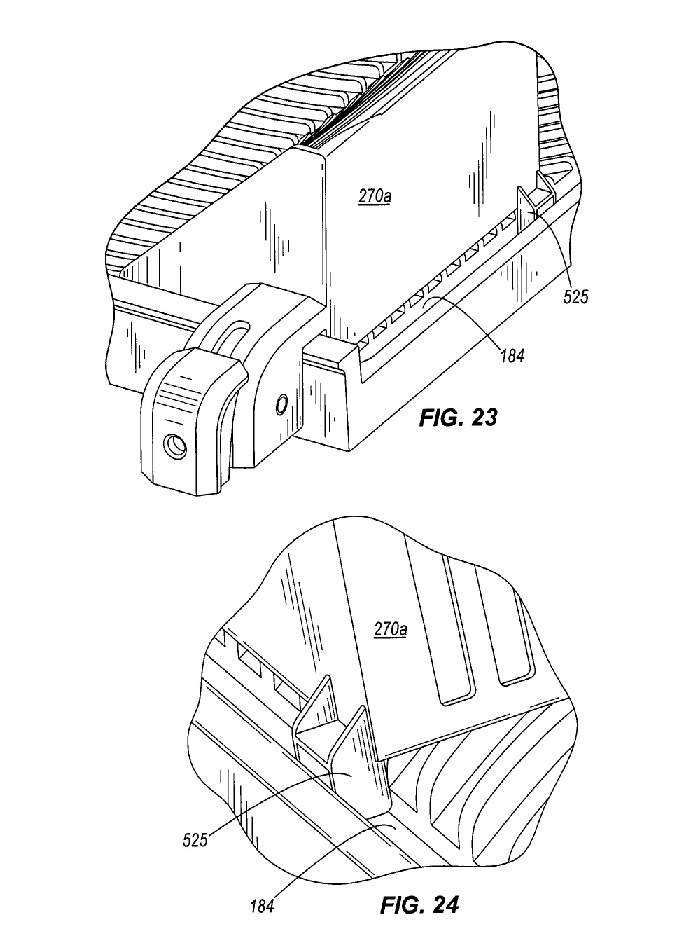

FIG. 22 schematically illustrates an alternative bevel block 270a that is similar to the bevel block 270. However, in addition to the features discussed with regard to the bevel block 270, the bevel block 270a further includes a tab 525 that extends from the bevel block 270a into the channel 184 of the table 170. As illustrated in FIGS. 23 and 24, preferred constructions employ a tab 525 that is formed integrally as one piece with the bevel block 270a. The tab 525 extends into the channel 184 to inhibit movement of the bevel block 270a in directions that are not parallel to the channel 184, while allowing movement along the channel 184. Thus, the tab 525 inhibits unwanted movement of the bevel block 270a during cutting operations and reduces waste and incorrectly cut tiles.

While FIGS. 23 and 24 illustrate a single tab 525, other constructions may employ additional tabs 525 that engage the channel 184 to inhibit unwanted movement. The use of additional tabs 525 has the advantage of providing some redundancy should one of the tabs 525 be accidentally broken off of the bevel block 270a. In still other constructions, the tab 525, or tabs 525, is a separate piece that attaches to the bevel block 270a.

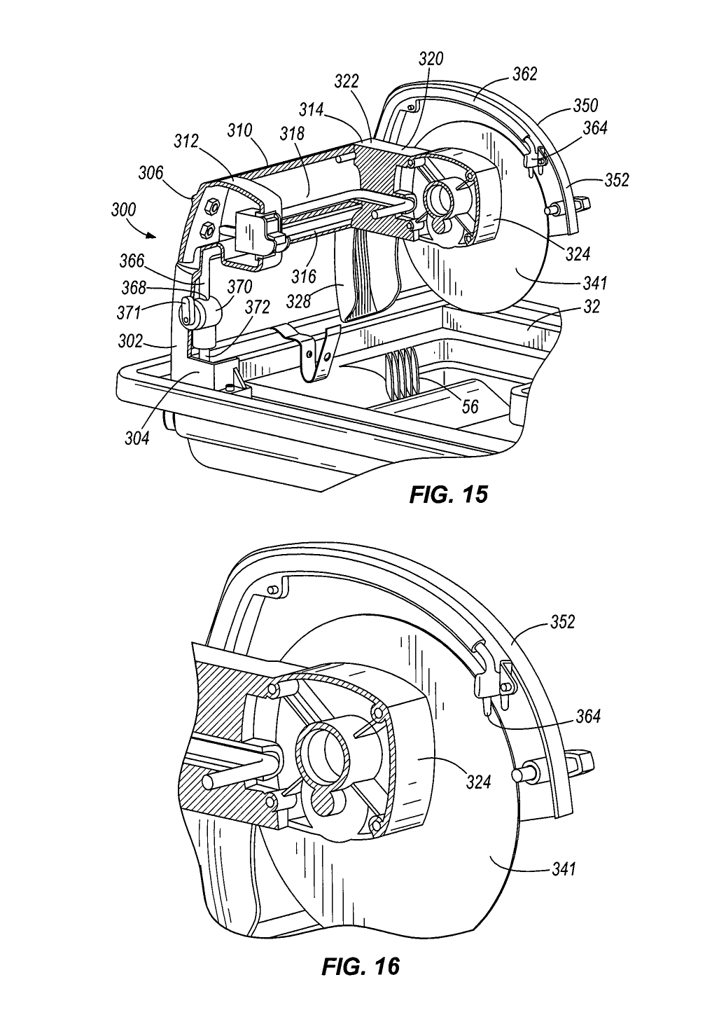

Referring to FIGS. 15 and 16, a saw support assembly 300 is supported by the frame assembly 150. The saw support assembly 300 is generally hollow, and constructed of a sturdy lightweight material such as cast aluminum. The saw support assembly 300 includes three portions, a column 302, an extension 310, and an arm 320. The saw support assembly 300 is configured to support the saw assembly 330 in a fixed position with respect to the base 20. It is contemplated, however, that either the extension 310 or the arm 320 can be configured to be movable with respect to the column 302 or the 20 base, and in particular with respect to the sides 28, 30 of the base 20 so that the distance between the cutting wheel 340 and either of the first or second side walls 28, 30 of the base 20 can be varied.

The column 302 has a first end 304 or base that is connected to the frame assembly 150 and a second end 306 that is connected to a first end 312 of the extension 310. The extension 310 extends at an angle from the column 302 and is generally parallel to the floor 22 of the base 20. As seen in FIG. 1, the column 302 is provided at a corner of the base 20 and is attached to the frame assembly 150 by screws. As noted above, the column 302 is attached to the extension 310 in a fixed manner, although it is contemplated that the extension 310 can be movable with respect to the column 302.

The second end 314 of the extension 310 extends from one side of the base toward the other side. The second end 314 of the extension 310 is located near the midpoint between the first side 28 and second side 30 of the base 20 so that the cutting wheel 340 will likewise be disposed near the midpoint between the first side 28 and second side 30 of the base 20. This location will help to keep the debris and fluid within the base 20 during the cutting operation. The second end of the extension 314 is connected to a first end 322 of the arm 320, which extends at an angle from the extension 310. The arm 320 is configured to support the saw assembly 330 so that the cutting wheel 340 is disposed over the base 20. In other words, referring to FIG. 1, the arm 320 extends from the extension 310 towards the front wall 24 of the base 20.

As shown in FIG. 1, the arm 320 is fixed with respect to the extension 310. It is contemplated, however, that the arm 320 be configured for movement along the extension 310 so that the arm 320 and thus the cutting wheel 340 can move in a lateral direction (i.e., in a direction from one side of the base toward the other). In addition, it is contemplated that the arm 320 be tiltable or pivotable with respect to the extension 310, particularly in one direction to provide a bevel cut. In this regard, the plane of the cutting wheel 340 can be moved from a substantially vertical position to a position offset from the vertical.

As best seen In FIG. 18, the extension 310 and the column 302 each have a separate connecting channel with the tubing for the fluid delivery assembly 360 being located in one channel 316, and the electrical wiring for the saw assembly 330 being located in the other separate channel 318. In this way, any fluid that might leak from the fluid delivery assembly 360 will not contact the electrical wiring for the saw assembly 330.

The saw assembly 330 includes a motor assembly 332 that includes a motor 334 and a housing 336 covering the motor 334. The motor assembly 332 is connected to the second end 324 of the arm 320. The motor 334 drives a spindle (not shown), which carries a cutting wheel 340. The cutting wheel 340 is partially covered by a guard assembly 350 that is described more fully below. A switch 342 to actuate the motor 334 is provided on the saw support assembly 300 to provide convenient access to the user. As seen in FIG. 1, the switch 342 is provided at the junction of the second end of the column 302 and the first end of the extension 310.

As mentioned above, the saw assembly 330 includes a guard assembly 350 that partially covers the cutting wheel 340. The guard assembly 350 includes a guard body 352 that partially covers at least the upper portion of the cutting wheel 340. The guard body 352 may be pivotably attached so that it can rotate with respect to the cutting wheel 340 to change the position of the guard body so that the operator can access the blade.

The guard assembly 350 includes a shield 358 at the rear of the cutting wheel 340 that extends in a downward direction. The shield 358 directs fluid carried by the cutting wheel 340 toward the base 20 to be collected.

Referring to FIGS. 15 and 16, the guard assembly 350 supports a portion of the fluid delivery assembly 360, which directs fluid, such as water, toward the cutting wheel 340 to cool the cutting wheel 340 and remove debris from the cutting area during the cutting operation. The fluid delivery assembly 360 includes a tube 362 having a first end 364 and a second end 366. The first end 364 is positioned adjacent the cutting wheel 340 and is configured to deliver fluid toward the cutting wheel 340. As seen in FIG. 15, the first end 364 is disposed on one side of the cutting wheel 340. The first end 364 could be disposed on the other side of the cutting wheel 340 or could be disposed near the outer peripheral edge of the cutting wheel 340. Alternatively, the first end 364 could be configured with two nozzles such that one nozzle is located on one side of the cutting wheel 340 and the other nozzle is located on the other side of the cutting wheel 340.

The second end 366 of the tube 362 is fluidly connected to an output 368 of a control valve 370 located on the column 302. It is contemplated, however, that the control valve 370 can be located elsewhere. The control valve 370 may be any suitable valve that operates to control fluid. For example, the control valve 370 may be a butterfly-type valve with a handle that is accessible from the exterior of the column 302. Accordingly, as the handle 371 is rotated the flow of fluid through the control valve 370 and thus delivered to the cutting wheel 340 may be controlled. Alternatively, the control valve 370 may be a valve that is an open and closed type valve, like a ball valve.

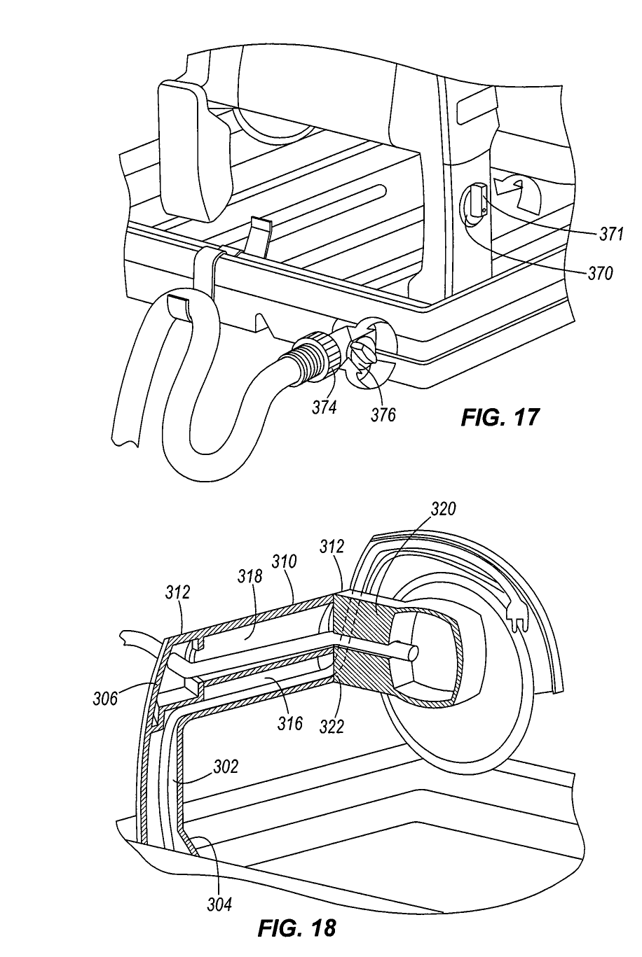

The input 372 of the control valve 370 is fluidly connected to a fluid source. As seen in FIG. 17, a connector 374 is provided at an exterior portion of the base 20. The connector 374 may receive fluid from an external fluid source such as a garden hose 378 or the like. The connector 374 includes a valve 376 such as a ball-type valve, a butterfly valve, gate valve, check valve, or any suitable valve. Because the fluid delivery system 360 includes two valves 370, 376, one of skill in the art will understand that the valves 370, 376 are interchangeable. The output of the connector 380, best seen in FIG. 5, is fluidly connected to the input of the control valve 372.

The fluid delivery assembly 360 is configured to have two modes of operation: a pump-less fluid delivery configuration and recycled fluid delivery configuration. During the pump-less fluid delivery configuration, fluid is continuously supplied to the saw from an external fluid source, such as a garden hose. It will be appreciated by one of skill in the art that when an external fluid source is used, the fluid pressure will generally be sufficient to move the fluid through the fluid delivery assembly 360 with suitable control by at least one of the control valves 370 and 376. Also, the continuous supply of new clean fluid, in conjunction with the continuous draining of fluid via the drain 54 assures cleaner fluid is provided at the cut and serves to remove debris from the table to provide a cleaner working surface.

As noted above, it is contemplated to provide a pump 390 within the base 20 for the recycled fluid delivery configuration. The pump 390 is used to pump fluid out of base 20 and into the input of the control valve 372 for recycling the fluid located in the base. The output of the pump 392 is fluidly connected to the input of the control valve 372 so that when the pump 390 is activated and the flow control valve 370 is opened, fluid will flow from the base 20 through the fluid delivery assembly 360. The pump 390 may be a submersible type pump and may be located within the base 20. Desirably, the pump 390 is located in an area of the base 390 circumscribed by the barrier 50, as shown in FIG. 5, which will prevent debris from the cutting operation from entering the pump 390 and moving through the fluid delivery assembly 360.

As mentioned above, the tile saw 10 includes a stop assembly 220. Referring back to FIG. 11, the stop assembly 220 is formed to provide a support for tubing 378 connected to the connector 374. In particular, the first arm 224 of the spring 222 has an extension 230 that is accessible from the exterior of the base 20, and in particular from the rear wall 26 of the base 20. The extension 230 is J-shaped to provide a hook to support a tube 278, one end of which may be connected to the connector 274.

The foregoing detailed description has described only a few of the many forms that this invention can take. For this reason, this detailed description is intended by way of illustration, and not by way of limitation. It is only the following claims, including all equivalents that are intended to define the scope of this invention.

1. A tile saw comprising:
a base;
a frame assembly disposed on the base;
a rail assembly disposed on the frame assembly,
a cutting table slidingly disposed on the rail assembly and including a front fence;
a saw assembly disposed on at least one of the base and the frame assembly, and including a motor and a cutting wheel driven by the motor; and,
one of a miter guide and a bevel block selectively lockable to the front fence.

2. The tile saw of claim 1, wherein the base has a floor and four walls extending from the base and configured to contain a liquid, and wherein the tile saw further comprises a barrier extending from the floor of the base and configured to hinder movement of non-fluid material suspended within the liquid.

3. The tile saw of claim 2, wherein the cutting table is movable beyond one of the walls of the base.

4. The tile saw of claim 3, further comprising a resilient stop assembly positioned to hinder movement of the cutting table past a selected distance beyond one of the walls of the base.

5. The tile saw of claim 1, further comprising a saw support assembly connected to the frame assembly and supporting the saw assembly, wherein the saw support assembly includes at least two separate channels configured to separate a fluid delivery assembly and a power delivery system.

6. The tile saw of claim 5, wherein the fluid delivery system includes a valve disposed on the saw support assembly.

7. The tile saw of claim 1, wherein the cutting table has a top surface with a plurality of arched grooves.

8. The tile saw of claim 7, wherein the front fence includes a surface perpendicular to the top surface of the cutting table.

9. The tile saw of claim 8, further comprising indicia located on a portion of the front fence and a portion of the top surface of the cutting table adjacent the front fence.

10. The tile saw of claim 1, wherein the base has at least one notch configured to receive a portion of a stand to support the base vertically above a support surface.

11. A tile saw comprising:
a base including a floor and at least one wall extending around a perimeter of the floor to at least partially enclose a space, the space adapted to contain a liquid coolant;
a saw assembly coupled to the base and supporting a blade, the blade rotatable about an axis that defines an axis plane;
a first rail coupled to the base and extending in a direction normal to the axis plane;
a second rail coupled to the base and positioned parallel to and spaced apart from the first rail;
a cutting table coupled to the first rail and the second rail and movable in a direction parallel to the first rail between a first position and a second position in which a portion of the cutting table extends beyond the perimeter;
a first bearing and a second bearing fixedly attached to the cutting table and movably engaged with the first rail; and
a third bearing fixedly attached to the cutting table and movably engaged with the second rail.

12. The tile saw of claim 11, further comprising a coolant supply system including a pump positioned in the base and an external supply connection coupled to the base, the pump and the external supply connection selectively operable to direct coolant along a coolant supply path to a guard positioned adjacent the blade.

13. The tile saw of claim 12, further comprising a barrier positioned to cooperate with the wall to surround the pump to define a pump space, and to inhibit the passage of solid material from the space to the pump space.

14. The tile saw of claim 13, wherein the barrier includes a top edge that is serrated.

15. The tile saw of claim 11, wherein the cutting table includes a plurality of arc-shaped grooves.

16. The tile saw of claim 11, wherein the cutting table includes a top surface including a high-friction material.

17. The tile saw of claim 11, wherein the cutting table includes a pair of corner supports positioned to support a rectangular workpiece for a cut that is not parallel to any side of the workpiece.

18. The tile saw of claim 11, wherein the first bearing includes two side portions and a U-shaped portion between the side portions.

19. The tile saw of claim 18, wherein the first bearing includes a support rib positioned near the center of the U-shaped portion.

20. The tile saw of claim 19, wherein each of the side portions defines a rail engaging surface such that the first rail contacts the first bearing at only the rail engaging surfaces and the support rib.

21. The tile saw of claim 11, further comprising a fourth bearing fixedly attached to the cutting table and movably engaged with the second rail.

22. The tile saw of claim 11, further comprising a stop assembly positioned to inhibit movement beyond an end of travel.

23. The tile saw of claim 22, wherein the stop assembly includes a biasing member that displaces as the cutting table approaches the end of travel to provide a feedback force to the user indicating that the cutting table is approaching the end of travel.

24. The tile saw of claim 11, further comprising a bevel block selectively coupled to the cutting table, the bevel block configured to support a workpiece at an oblique angle with respect to a top surface of the cutting table.

25. The tile saw of claim 24, wherein the bevel block includes a workpiece support surface that includes a plurality of arc-shaped grooves.

26. The tile saw of claim 24, wherein the cutting table includes a slot that extends in a direction parallel to the first rail and the bevel block includes a tab that engages the slot.

27. The tile saw of claim 11, further comprising a coolant supply system including an external supply connection coupled to the base and a drain formed in the base, wherein the external supply connection is arranged to provide for the continuous supply of coolant and the drain is arranged to provide for the continuous removal of coolant during a cutting operation.

28. A tile saw comprising:
a base including a floor and at least one wall extending around a perimeter of the floor to at least partially enclose a space, the space adapted to contain a coolant;
a saw assembly coupled to the base and supporting a blade, the blade rotatable about an axis that defines an axis plane;
a first rail coupled to the base and extending in a direction normal to the axis plane;
a second rail coupled to the base and positioned parallel to and spaced apart from the first rail; and
a cutting table coupled to the first rail and the second rail and movable in a direction parallel to the first rail between a first position and a second position in which a portion of the cutting table extends beyond the perimeter, the cutting table including a top surface having a plurality of arc-shaped grooves.

29. The tile saw of claim 28, further comprising a coolant supply system including a pump positioned in the base and an external supply connection coupled to the base, the pump and the external supply connection selectively operable to direct coolant along a coolant supply path to a guard positioned adjacent the blade.

30. The tile saw of claim 29, further comprising a barrier positioned to cooperate with the wall to surround the pump to define a pump space, and to inhibit the passage of particulates from the space to the pump space, the barrier including a top edge that is serrated.

31. The tile saw of claim 28, wherein the cutting table includes a pair of corner supports positioned to support a rectangular workpiece for a cut that is not parallel to any side of the workpiece.

32. The tile saw of claim 28, further comprising a bearing fixedly attached to the cutting table and movably engaged with the first rail.

33. The tile saw of claim 32, wherein the bearing includes two side portions and a U-shaped portion between the side portions.

34. The tile saw of claim 33, wherein the bearing includes a support rib positioned near the center of the U-shaped portion.

35. The tile saw of claim 34, wherein each of the side portions defines a rail engaging surface such that the first rail contacts the bearing at only the rail engaging surfaces and the support rib.

36. The tile saw of claim 28, further comprising a stop assembly positioned to inhibit movement beyond an end of travel.

37. The tile saw of claim 36, wherein the stop assembly includes a biasing member that displaces as the cutting table approaches the end of travel to provide a feedback force to the user indicating that the cutting table is approaching the end of travel.

38. The tile saw of claim 28, further comprising a bevel block selectively coupled to the cutting table, the bevel block configured to support a workpiece at an oblique angle with respect to a top surface of the cutting table.

39. The tile saw of claim 38, wherein the bevel block includes a workpiece support surface that includes a plurality of arc-shaped grooves.

40. The tile saw of claim 38, wherein the cutting table includes a slot that extends in a direction parallel to the first rail and the bevel block includes a tab that engages the slot.

41. The tile saw of claim 28, further comprising a coolant supply system including an external supply connection coupled to the base and a drain formed in the base, wherein the external supply connection is arranged to provide for the continuous supply of coolant and the drain is arranged to provide for the continuous removal of coolant during a cutting operation.
